(19) United States
(12) Patent Application Publication
(10) Pub. No.: US 2007/0182168 A1
(43) Pub. Date: Aug. 9, 2007

(54) Method and apparatus for shimming door latch keeper plate

(76) Inventor: Randy Grant Allen, Colorado Springs, CO (US)

Correspondence Address: RICK B. YEAGER, ATTORNEY, 10805 MELLOW LANE, AUSTIN, TX, 78759, US

(21) Appl. No.: 11/625,808

(22) Filed: Jan. 22, 2007

Related U.S. Application Data
(60) Provisional application No. 60/761,240, filed on Jan. 23, 2006.

(51) Int. Cl. E05B 15/02

(52) U.S. Cl. 292/340

(57) ABSTRACT

Shims are provided to be placed behind a door jamb strike plate in order to reduce the distance between the door edge and the strike plate. Decreasing the distance between the strike plate and the door permits the dead latch or the locking arm of a door latch to more fully engage a hole in the strike plate so that the door may be held shut. The shims may have various thicknesses and may be used in combination to achieve a desired overall adjustment. The shims are typically plastic which is provided in the shape of the strike plate or cut to a desired shape. The shims may be placed either at the time of a door installation, or at a later date when the door or jamb may have settled, or expanded slightly.

This is a U.S. Non-Provisional patent application. This application claims the filing date of U.S. Provisional Application No. 60/761,240 filed Jan. 23, 2006 by applicant.

### BACKGROUND

1. Field of Invention

The current invention relates to adjusting the distance between a door frame latch plate and door by installing one or more shims behind a strike plate.

2. Prior Art

Prior art devices typically provide a shim device behind one or both of an upper hinge and a lower hinge. These types of devices permit a leveling of the door in addition to moving at least a portion of the door closer to the strike plate. However, the hinge shims have the disadvantage in installation of being relatively difficult to install because at least one of the hinge plates must be removed from either the door jamb or from the door.

There is a need for a device which is easy to install, and which solves the problem of a door latch being slightly too far away from a strike plate to allow the door to latch securely. The current invention addresses that common need, with a device that is simple to install.

### SUMMARY OF INVENTION

The purpose of strike plate shims is to decrease the gap between a door latch and a strike plate by moving the strike plate closer to the door. Decreasing the distance between the strike plate and the door permits the dead latch or the locking arm of a door latch to more fully engage a hole in the strike plate so that the door may be held shut.

In the current invention, one or more shims may be placed between the strike plate and the door jamb. The shims may be placed either at the time of a door installation, or at a later date when the door or jamb may have settled slightly.

The shim or shims move the strike plate, thereby increasing the overlap of the dead latch or locking arm into the strike plate, and enhancing or facilitating door closure and locking.

### DESCRIPTION OF FIGURES

FIG. 1 is a top view of a latch plate shim 100 comprising a first hole 110 for a latch plate attachment screw, a second hole 112 for a plate attachment, and a large cutout 114 for a dead bolt or latch.

FIG. 2A is a side view of a shim having a first thickness.

FIG. 2B is a side view of a shim having a second thickness.

FIG. 2C is a side view of a shim having a third thickness.

FIG. 3 is a bottom view of the latch shim plate.

FIG. 4 is an exploded view of a door jamb frame 150 with a cutout 152 for a strike plate, a first shim 100a, a second shim 100b, and a strike plate 160.

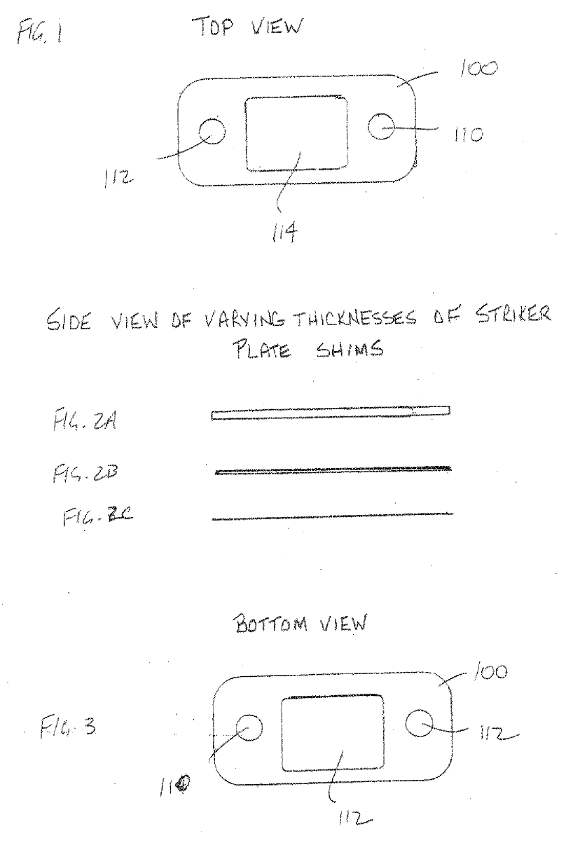

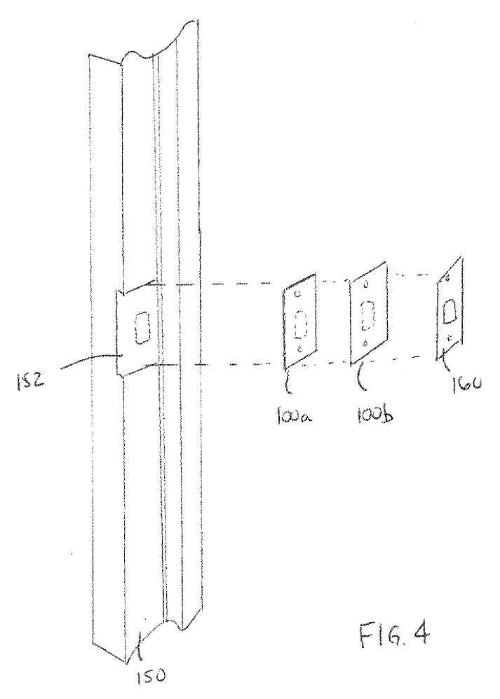

### DETAILED DESCRIPTION OF INVENTION

The strike plate shims are installed by simply removing the existing strike plate by unscrewing it from the door frame and placing one or more strike plate shims, depending on thickness, underneath the strike plate and reinstalling the strike plate into the door frame.

In another example, one or more shims is installed at the time of a new door installation in response to either an undesirably large gap between the door and the strike plate, or in the case where a strike plate recess is etched too deeply into a door jamb.

The general profile of the strike plate shim may mirror the general profile of the strike plate. Most strike plate profiles are either rectangular, or generally rectangular with rounded corners. Other decorative strike plates come in a variety of shapes.

In one example, a set of striker plate shims are provided in a uniform design in order to allow their application in the widest variety of standard manufactured door knob sets. In another example, the shims are provided in a soft plastic material that is easy to cut so that the shim may be trimmed to the striker plate profile, either before or after striker plate installation.

The shim is designed to be simply placed underneath the existing strike plate in the door frame. The strike plate shims may be made of a resin, plastic or other suitable non-compressible material. The shims are typically provided in various thicknesses from about 1/16 inch (1.6 mm) to about 5/32 inch (4 mm).

In some applications, two or more shims may be used.

Strike plate shims are both a convenient and easy remedy for doors that no longer adequately or properly close or lock due to warpage, shrinkage, improper installation or inadequate spacing caused from foundation settling or other structural changes affecting hinged doorways.

What is claimed is:

1. A shim for a door latch striker plate, the shim comprising
a generally planar base material;
a first hole in the base material to accommodate a retractable latch bar; and
a pair of mounting holes in the base material, such that the pair of mounting holes will accommodate a pair of striker plate mounting screws.

2. The shim of claim 1 wherein the base material is a plastic.

3. The shim of claim 1 wherein the base material is provided in a size larger than the striker plate such that the shim may be cut to a desired shape.

4. The shim of claim 1 wherein the base material is provided in the shape of the striker plate.

5. The shim of claim 4 wherein the shape of the striker plate and base material is rectangular.

6. The shim of claim 4 wherein the shape of the striker plate and base material is generally rectangular with rounded corners.

7. A method for improving the latch performance of a door latch system, the door latch system comprising a latch, a retractable latch bar, and a striker plate, the method comprising
providing at least one striker plate shim, the shim comprising
a generally planar base material provided in the shape of the outline of the striker plate,
a first hole in the base material to accommodate a retractable latch bar, and
a pair of mounting holes in the base material, such that the pair of mounting holes will accommodate a pair of striker plate mounting screws; and
placing the shim under the striker plate.

8. The method of claim 7 wherein placing the shim under the striker plate further comprises placing the shim before a striker plate is installed.

9. The method of claim 8 further comprising cutting the shim to the outline shape of the striker plate before the shim is placed under the striker plate.

10. The method of claim 8 further comprising placing more than one shim under the striker plate.

11. The method of claim 7 wherein placing the shim under the striker plate further comprises
removing the striker plate;
positioning the shim; and
installing the striker plate so that the shim is located under the striker plate.

12. The method of claim 11 further comprising cutting the shim to the outline shape of the striker plate after installing the striker plate.

13. The method of claim 11 further comprising
positioning a plurality of shims; and
installing the striker plate so that the plurality of shims is located under the striker plate.
